(19) United States
(12) Patent Application Publication
(10) Pub. No.: US 2011/0005678 A1
(43) Pub. Date: Jan. 13, 2011

(54) CORRUGATED BOARD USING ACID TREATED ZEOLITES

(76) Inventor: KANG HYEON NAM, Irvine, CA (US)

Correspondence Address: MAXON IP LLC, 46175 WESTLAKE DR., SUITE 410, POTOMAC FALLS, VA, 20165, US

(21) Appl. No.: 12/502,116

(22) Filed: Jul. 13, 2009

(51) Int. Cl. B32B 37/12; C09J 103/02

(52) U.S. Cl. 156/325; 106/217.3

(57) ABSTRACT

A method of manufacturing corrugated board uses acid treated zeolite to maintain the freshness of various natural food products for an extended period of time. The method of manufacturing corrugated board using acid treated zeolite comprises a zeolite acid treating process, an adhesive making process, an adhesive applying process, and a board assembling process wherein a corrugated sheet is layered between an upper liner sheet and a lower liner sheet which is then bonded to form a corrugated board. A significant advantage of this invention is that removing the filth or dirt by pre-processing the zeolite with acid treatment maximizes the freshness of food products stored in the corrugated box.

### BACKGROUND OF THE INVENTION

The present invention generally relates to a method of manufacturing corrugated board. More particularly, this invention relates to a method of manufacturing corrugated board using acid treated zeolite to maintain the freshness of various natural food products for an extended period of time.

Zeolites are commonly known for having a porous structure that can be readily dehydrated and rehydrated, and are used as cation exchangers and molecular sieves. There have been proposed methods of manufacturing corrugated boards using cornstarch and the zeolites for extended freshness to utilize the porous structure.

However, in reality, the pores in the natural zeolite are mostly filled with filth or dirt, thereby closing the pores, making it impossible to exhibit high absorption and cation exchange capability.

In addition, conventional techniques of using the adhesive for the corrugated board have been problematic because the particle of the zeolite powder is not soluble, and thus the zeolite powder is easily separated and forms into unwanted clots in the course of usage.

Accordingly, there is a need for removing the filth or dirt by pre-processing the zeolites with acid treatment and preparing it into fine powders, thereby maximizing the freshness of food products stored in the corrugated box.

### BRIEF SUMMARY OF THE INVENTION

The present invention provides a method of manufacturing corrugated board using acid treated zeolite to maintain the freshness of various natural food products for an extended period of time.

The method of manufacturing corrugated board using acid treated zeolite comprises a zeolite acid treating process, an adhesive making process, an adhesive applying process, and a board assembling process wherein a corrugated sheet is layered between an upper liner sheet and a lower liner sheet which is then bonded to form a corrugated board.

In view of the above, it can be seen that a significant advantage of this invention is that removing the filth or dirt by pre-processing natural zeolites with concentrated acid maximizes the freshness of food products stored in the corrugated box.

Other advantages of this invention will be better appreciated from the following detailed description.

### BRIEF DESCRIPTION OF THE DRAWINGS

FIG. 1 shows a flow chart illustrating the process of manufacturing the corrugated board using the acid treated zeolite, according to the present invention.

FIG. 2 shows a flow chart illustrating the process regarding the zeolite acid treatment, according to the present invention.

FIG. 3 shows a table illustrating the elements of the various adhesives, according to the present invention.

FIG. 4 shows the process of applying the adhesive coming from a pair of rollers and assembling the corrugated board according to the present invention.

FIG. 5 shows the process of applying the adhesive in both a pair of rollers and a pair of sprayers, according to the present invention.

### DESCRIPTION OF THE INVENTION

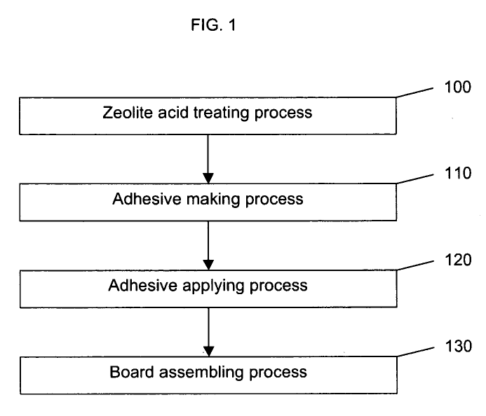

Illustrated in FIG. 1 is a flow chart showing the process of manufacturing the corrugated board using the acid treated zeolite, according to the present invention. The corrugated board manufacturing process is comprised of zeolite acid treatment process 100, adhesive making process 110, adhesive applying process 120, and board assembling process 130.

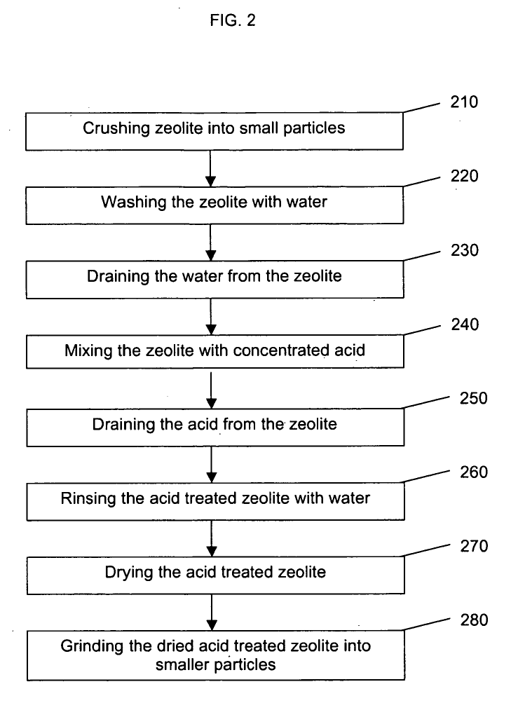

FIG. 2 shows a flow chart illustrating the process of the zeolite acid treatment, according to the present invention. The process includes the following steps: crushing zeolite into small particles 210, washing the zeolite with water 220, draining the water from the zeolite 230, mixing the zeolite with concentrated acid 240, draining the acid from the zeolite 250, rinsing the acid treated zeolite with water 260, drying the acid treated zeolite 270, and grinding the dried acid treated zeolite into smaller particles 280.

The zeolite being used in the present invention is natural state zeolite. At step 210, the zeolite is crushed to have a preferred particle size of 0.5 to 2 mm. Next, the zeolite is washed with clean water at step 220. Then, the water is naturally drained from the zeolite at step 230.

At step 240, a concentrated acid is added and mixed with the zeolite for about 30 minutes to one hour. The amount of the concentrated acid is preferably about 20% in weight of the zeolite.

Subsequently, the acid is drained from the zeolite at step 250. At step 260, the water is added to the acid treated zeolite to be washed out and drained. This step is preferably repeated three to five times. The acid treated zeolite is then placed into a dryer to dehydrate at step 270. As a final step 280, an acid treated zeolite powder is obtained by grinding the previously dried acid treated zeolite into smaller particles.

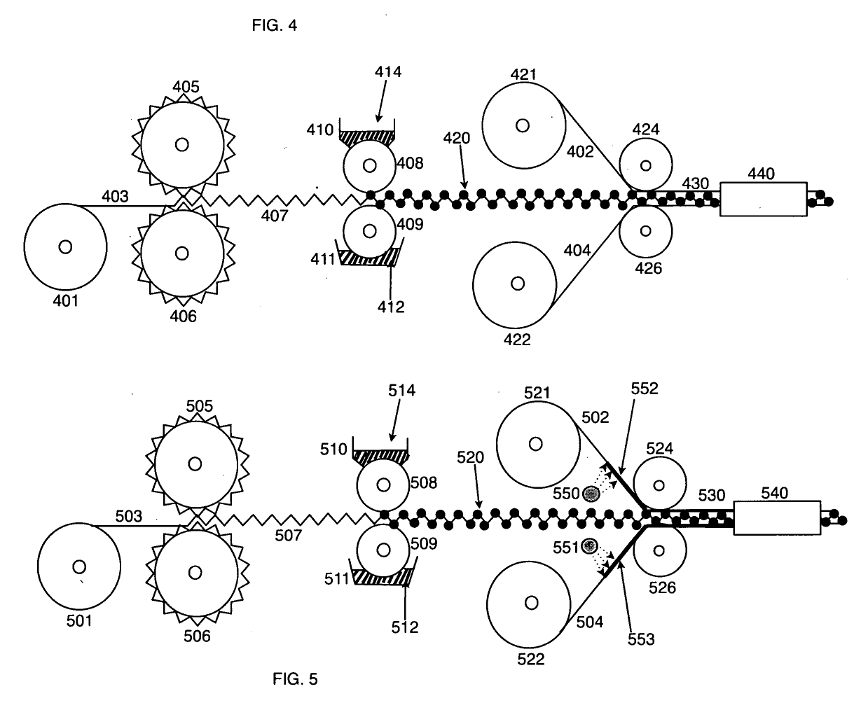

The particle size of the zeolite powder used in the acid treating process is determined depending on what type of adhesive applying method is utilized. For example, if the method is set to “Roller Type” as seen FIG. 4, then the preferred particle size should be at least 400 meshes. Here, the term “mesh”, which is a unit indicating a sieve opening or a particle size, is defined as the number of openings per liner inch in a Tyler standard sieve. If the method is set to “Spray Type” as seen FIG. 5, then the preferred particle size should be at least 250 meshes.

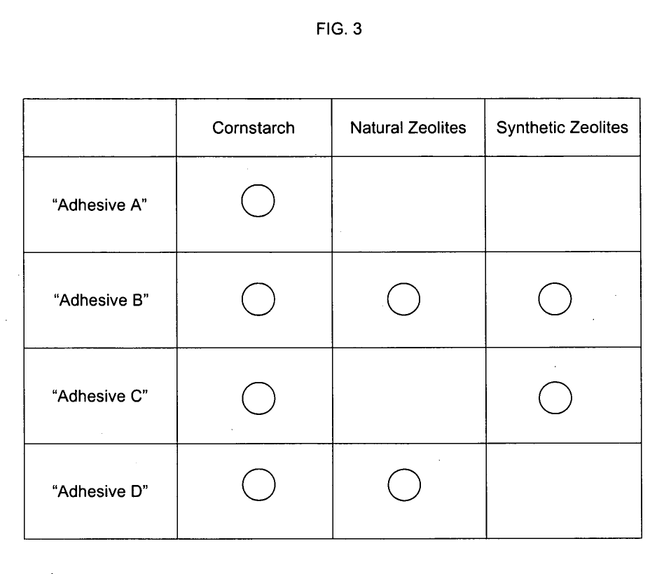

FIG. 3 shows a table illustrating the element of the various adhesives, according to the present invention. Four different types of adhesives can be obtained by mixing different elements: a cornstarch, an acid treated zeolite powder, and a synthetic zeolite powder (note that the synthetic zeolite powder is obtained by grinding synthetic zeolites that are not acid treated). For example, “Adhesive A” is defined as consisting of the cornstarch only. “Adhesive B” is defined as consisting of the cornstarch, the acid treated zeolite powder, and the synthetic zeolite powder. “Adhesive C” is defined as consisting of both the cornstarch and the synthetic zeolite powder. “Adhesive D” is defined as consisting of both the cornstarch and the acid treated zeolite powder.

A porous adhesive (Adhesive B, C, and D) is obtained by blending a mixture comprised of about 75% wt % cornstarch, about 25% wt % zeolite powder, a sodium hydroxide, and a box hardener with water. And a cornstarch adhesive (Adhesive A) is obtained by blending a mixture comprised of about 100% wt % cornstarch, a sodium hydroxide, and a box hardener with water.

FIG. 4 shows “Roller Type” process of applying the adhesive coming from a pair of adhesive rollers 408, 409, and assembling the corrugated board 430 according to the present invention. A middle sheet 403 is came out of middle sheet roller 401 and is passed through a pair of molding rollers 405, 406, thereby creating a corrugated sheet 407. Adhesive 412, 414 each is filled in both adhesive containers 410, 411 and is then uniformly applied onto top and bottom surfaces of the corrugated sheet 407 by using a pair of adhesive rollers 408, 409. In this roller type, the adhesive 412, 414 is the porous adhesive (one of Adhesive B, Adhesive C, and Adhesive D).

As seen FIG. 4, the corrugated sheet 407 which was coated with the adhesive 420 is layered between an upper liner sheet 402 and a lower liner sheet 404 rolling out of a pair of sheet rollers 421, 422 to create a corrugated board. And then, the corrugated board is passed through a pair of press rollers 424, 426, thereby bonding the sheets of the corrugated board 430. Then, the corrugated board 430 is passed through a dryer tunnel 440.

FIG. 5 shows “spray type” process of applying the adhesives to each inside surfaces of an upper liner sheet 552 and a lower liner sheet 553, and assembling a corrugated board 530 according to the present invention. A middle sheet 503 is came out of middle sheet roller 501 and is passed through a pair of molding rollers 505, 506, thereby creating a corrugated sheet 507. Adhesive 512, 514 each is contained in both adhesive containers 510, 511, and is uniformly applied onto top and bottom surfaces of the corrugated sheet 507 by using a pair of adhesive rollers 508, 509. Preferably, the adhesive coming from the roller 508,509 is “Adhesive A” which contains 100% cornstarch.

As illustrated in FIG. 5, a pair of sprayers 550, 551 applies adhesive 552, 553 to each inside surfaces of the upper liner sheet 502 and the lower liner sheet 504 wherein the adhesive is the porous adhesive (one of “Adhesive B”, “Adhesive C”, and “Adhesive D”) that has previously described in FIG. 3. Accordingly, the corrugated sheet 507, which was coated with the cornstarch adhesive (“Adhesive A”), is layered between the upper liner sheet 502 and the lower liner sheet 504 to create a corrugated board. And then, the board is passed through a pair of press rollers 524, 526, thereby bonding the sheets of the corrugated board 530. Subsequently, the board 530 is passed through a dryer tunnel 540.

While the invention has been described in terms of preferred embodiments, it is apparent that other forms could be adopted by one skilled in the art. Accordingly, it should be understood that the invention is not limited to the specific embodiments illustrated in the FIGS. 1-5. It should also be understood that the phraseology and terminology employed above are for the purpose of disclosing the illustrated embodiments, and do not necessarily serve as limitations to the scope of the invention.

1. A method of manufacturing corrugated board comprising:
a zeolite acid treating process wherein an acid treated zeolite is obtained by the followings steps: crushing a zeolite to have a particle size ranging from about 0.5 to about 2.0 mm, washing the zeolite with water, draining the water from the zeolite, mixing the zeolite with a concentrated acid for a prolonged time, draining the acid from the zeolite, rinsing the zeolite with clean water, drying the zeolite, and preparing an acid treated zeolite powder obtained by grinding the dried acid treated zeolite into smaller particles;
an adhesive making process wherein a porous adhesive is obtained by blending a mixture comprised of about 75% wt % cornstarch, about 25% wt % zeolite powder, a sodium hydroxide, and a box hardener with water;
an adhesive applying process wherein the porous adhesive is applied on top and bottom surfaces of a corrugated sheet by using a pair of rollers; and
a board assembling process wherein the corrugated sheet is layered between an upper liner sheet and a lower liner sheet which is then bonded to form a corrugated board.

2. The method according to claim 1, wherein the zeolite used in the acid treating process is a natural zeolite.

3. The method according to claim 1, wherein the acid treated zeolite powder used in the acid treating process has a particle size of at least 400 meshes.

4. The method according to claim 1, wherein the zeolite powder used in the adhesive making process is comprised of the acid treated zeolite powder and a synthetic zeolite powder.

5. A method of manufacturing corrugated board comprising:
a zeolite acid treating process wherein an acid treated zeolite is obtained by the followings steps: crushing a zeolite to have a particle size ranging from about 0.5 to about 2.0 mm, washing the zeolite with water, draining the water from the zeolite, mixing the zeolite with a concentrated acid for a prolonged time, draining the acid from the zeolite, rinsing the zeolite with clean water, drying the zeolite, and preparing an acid treated zeolite powder obtained by grinding the dried acid treated zeolite into smaller particles;
an adhesive making process wherein a porous adhesive is obtained by blending a mixture comprised of about 75% wt % cornstarch, about 25% wt % zeolite powder, a sodium hydroxide, and a box hardener with water, and a cornstarch adhesive is obtained by blending a mixture comprised of about 100% wt % cornstarch, a sodium hydroxide, and a box hardener with water;
an adhesive applying process wherein the cornstarch adhesive is applied on top and bottom surfaces of a corrugated sheet by using a pair of rollers, and the porous adhesive is sprayed onto each inside surfaces of an upper liner sheet and a lower liner sheet; and
a board assembling process wherein the corrugated sheet is layered between an upper liner sheet and a lower liner sheet which is then bonded to form a corrugated board.

6. The method according to claim 5, wherein the zeolite used in the acid treating process is a natural zeolite.

7. The method according to claim 5, wherein the acid treated zeolite powder used in the acid treating process has a particle size of at least 250 meshes.

8. The method according to claim 5, wherein the zeolite powder used in the adhesive making process is comprised of the acid treated zeolite powder and a synthetic zeolite powder.

9. A method of making porous adhesive comprising:
a zeolite acid treating process wherein an acid treated zeolite is obtained by the followings steps: crushing a zeolite to have a particle size ranging from about 0.5 to about 2.0 mm, washing the zeolite with water, draining the water from the zeolite, mixing the zeolite with a concentrated acid for a prolonged time, draining the acid from the zeolite, rinsing the zeolite with clean water, drying the zeolite, and preparing an acid treated zeolite powder obtained by grinding the dried acid treated zeolite into smaller particles; and
an adhesive making process wherein a porous adhesive is obtained by blending a mixture comprised of about 75% wt % cornstarch, about 25% wt % zeolite powder, a sodium hydroxide, and a box hardener with water.

10. The method according to claim 9, wherein the zeolite used in the acid treating process is a natural zeolite.

11. The method according to claim 9, wherein the acid treated zeolite powder used in the acid treating process has a particle size of at least 250 meshes.

12. The method according to claim 9, wherein the zeolite powder used in the adhesive making process is comprised of the acid treated zeolite powder and a synthetic zeolite powder.
